(19) United States
(12) Patent Application Publication
(10) Pub. No.: US 2006/0053678 A1
(43) Pub. Date: Mar. 16, 2006

(54) Fish luring device

(76) Inventor: Greg Amsler, Stacy, MN (US)

Correspondence Address: Moss & Barnett P.A.;4800 Wells Fargo Center, 90 South Seventh Street, Minneapolis, MN, 55402-4129, US

(21) Appl. No.: 11/226,108

(22) Filed: Sep. 14, 2005

Related U.S. Application Data
(60) Provisional application No. 60/610,410, filed on Sep. 16, 2004.

(51) Int. Cl. A01K 85/01

(52) U.S. Cl. 43/42.31; 43/44.87; 43/43.1

(57) ABSTRACT

A fish luring device for bouncing on the floor of a body of water to attract fish. The device has a weighted body structured to allow easy vertical movement in the water, thereby increasing the speed at which the weighted body contacts the floor of the body of water. A coupling member is disposed on the weighted body for detachably coupling the weighted body to a fishing line and for coupling a leader line and fishing hook to the weighted body. A noise generating mechanism may be disposed in or on the weighted body for generating disturbances in the water and attracting fish.

### CLAIM OF PRIORITY

This utility application claims priority to U.S. Provisional Application Ser. No. 60/610,410 filed Sep. 16, 2004, which is incorporated herein in its entirety.

### FIELD OF THE INVENTION

The present invention relates generally to fishing tackle. More specifically, the invention relates to a fish luring device that lures or attracts fish by bouncing on the bottom of a river or lake.

### BACKGROUND OF THE INVENTION

The use of various fish luring devices is known. A first type of fish luring device, or fishing lure, is often called a drop shot. U.S. Pat. No. 5,369,905, incorporated herein by reference, discloses a device similar to a drop shot. A drop shot typically includes a weighted body coupled to an end of a fishing line. A length of fishing line or a leader line having a fishing hook attached thereto is typically coupled to a portion of the fishing line a distance above the weighted body. When an angler drops the weighted body into the water it comes to rest upon the floor of the lake or river. The leader is free to float above the floor. A disadvantage with the drop shot is that the only lure is the bait on the fishing hook. With all of the debris in the water, the bait on the fishing hook can be easily ignored.

Another typical fishing lure is the walking lure. U.S. Pat. Nos. 3,468,053; 4,750,289; 2,589,715; and 4,428,144, incorporated herein by reference, are examples of walking lures. As particularly illustrated in these examples, a walking lure typically includes an elongated weighted body that is coupled to the end of a fishing line. A leader line with a fishing hook is typically attached to the fishing line or lead line. When an angler fishes with a walking lure, the elongated weighted body is typically dragged along the floor of the body of water to raise debris and attract fish to the bait on the lure. A disadvantage of the walking lures is that they are easily caught up in weeds and obstacles on the floor of the body of water.

What is needed is a fishing lure device that can easily bounce on the floor of the body of water to raise debris and attract fish. What is also needed is a fishing lure device that avoids becoming entangled in weeds and other debris on the floor of the body of water.

### BRIEF SUMMARY OF THE INVENTION

The invention in particular embodiments has a weighted body structured to allow easy vertical movement in the water to increase the speed at which the weighted body contacts the floor of the body of water. An attaching member is disposed on the weighted body for releaseably attaching the weighted body to a fishing line and for attaching a leader line and fishing hook to the weighted body. A noise generating assembly is disposed to the weighted body for generating disturbances in the water and attracting fish.

The above summary of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a side view of the fishing lure device in water and showing the vertical direction of movement;

FIG. 2 is a side view of the weighted body and attachment member;

FIG. 3 is another side view of the weighted body and attachment member;

FIG. 4 is top view of the weighted body and attachment member;

FIG. 5 is a bottom view of the weighted body and attachment member;

FIG. 6 is a side view of another embodiment of the invention having a noise generating assembly disposed in the weighted body;

FIG. 7 is a side view of another embodiment of the invention having a noise generating assembly disposed in the weighted body; and

FIG. 8 is a side view of the invention in use.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents and alternatives falling within the spirit and scope of the invention as defined by the appended claims.

### DETAILED DESCRIPTION OF A PREFERRED EMBODIMENT

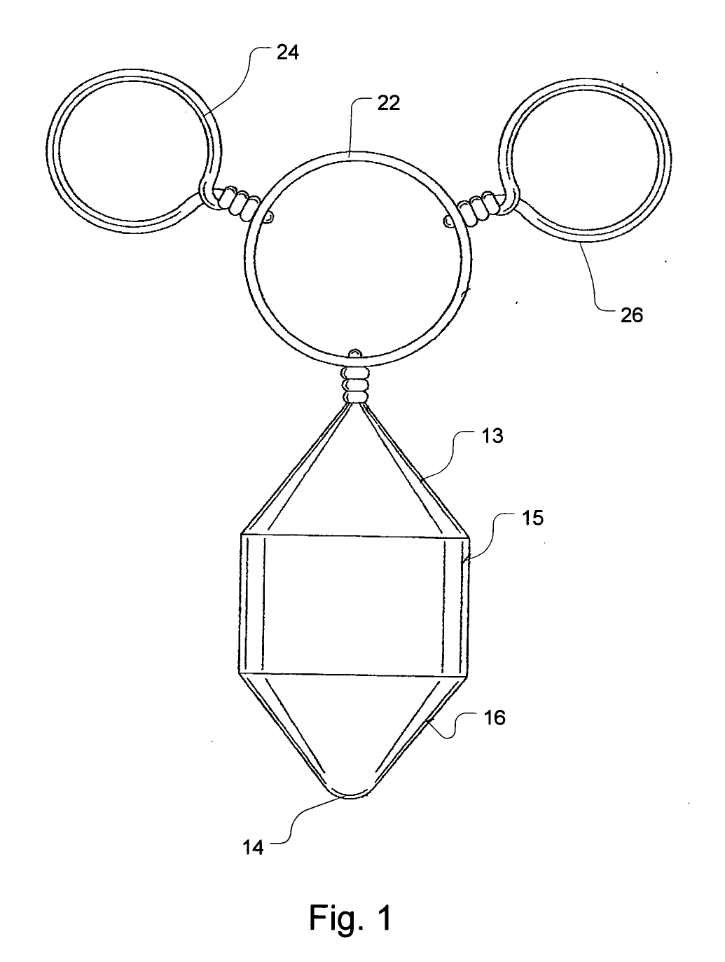

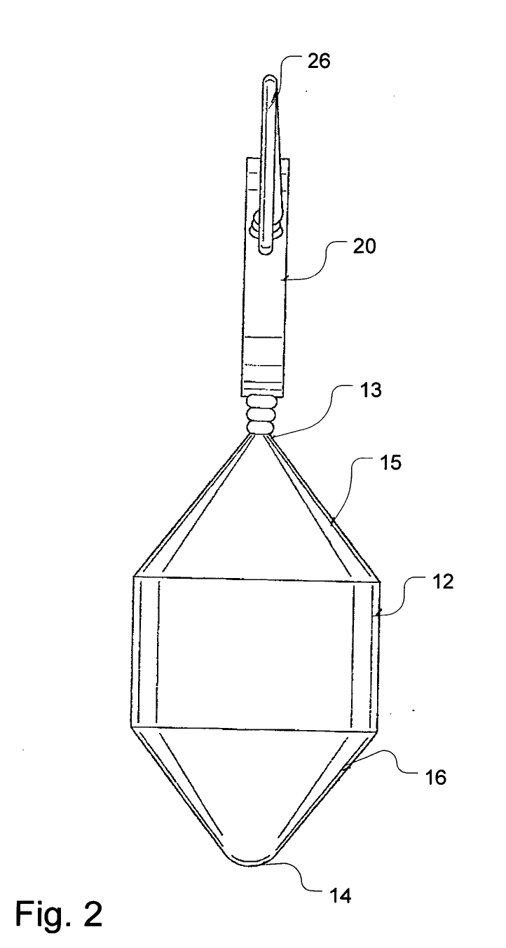

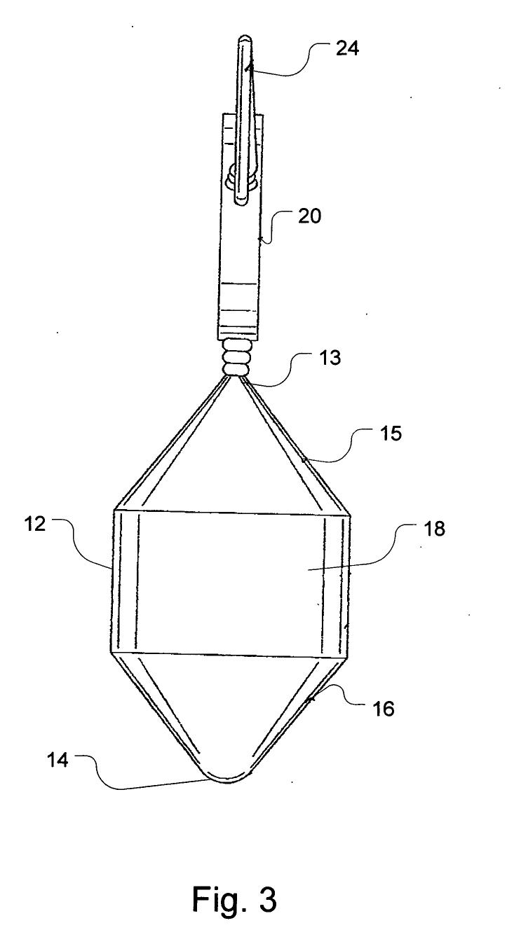

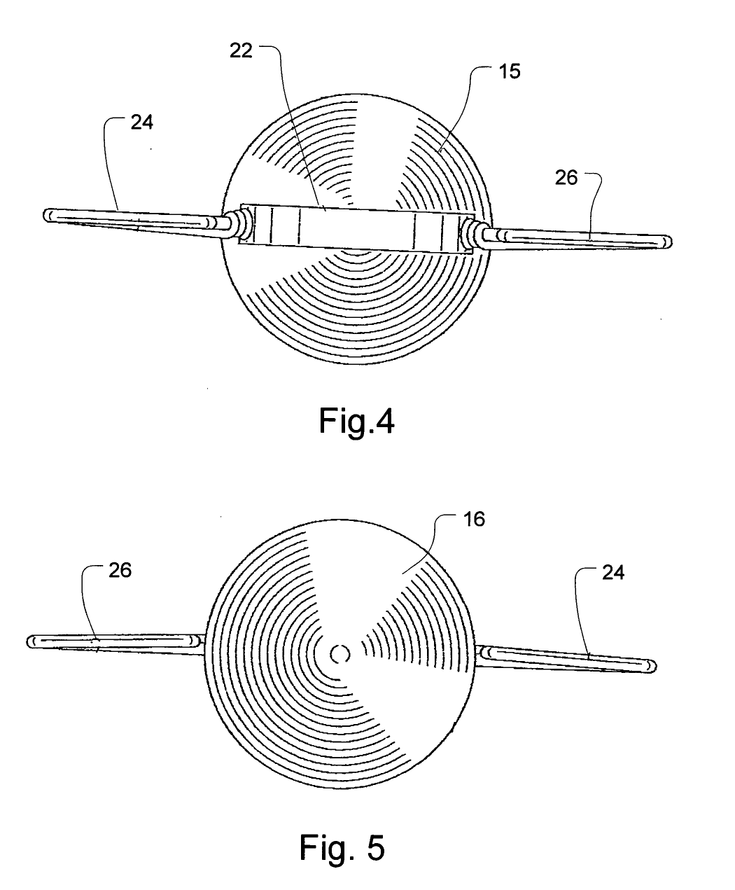

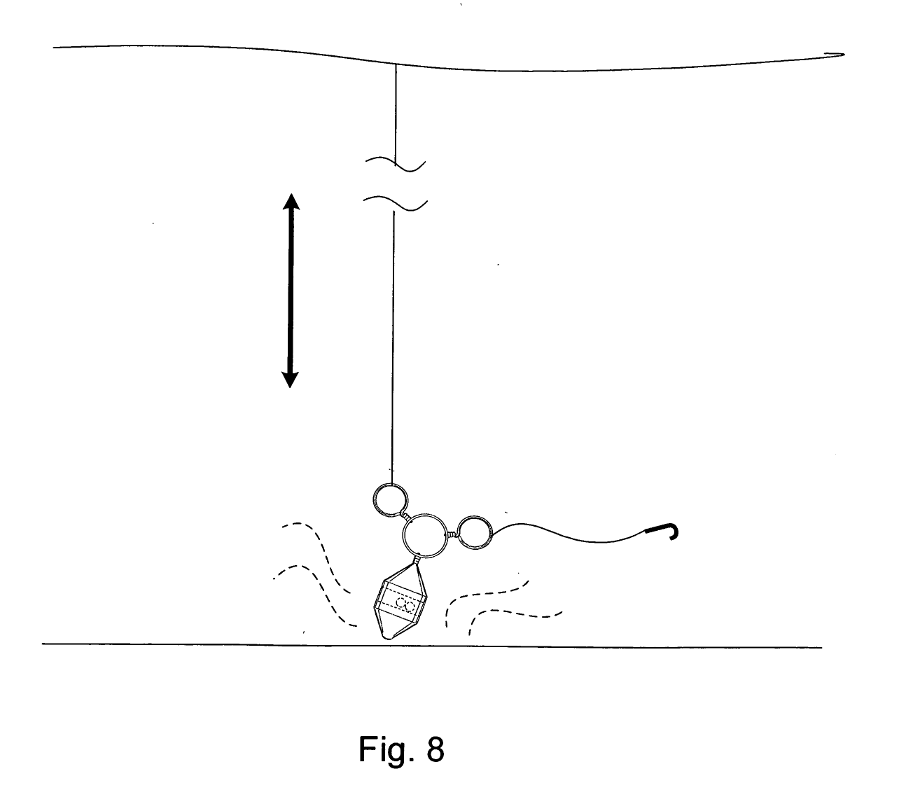

Referring to FIGS. 1-8, a fish luring device generally denoted by the numeral 10 is provided for bouncing on or against the floor of a body of water containing fish in order to lure the fish toward bait that may be attached to the device. In one embodiment, as illustrated in FIG. 1, a weighted body 12 is provided for bouncing or banging against a floor of a body of water to lure fish to the debris raised therefrom. Referring to FIG. 2, the weighted body 12 may have a first end 13 and a second end 14. The weighted body 12 may also have a generally conical upper portion 15 and a generally conical lower portion 16 for permitting the weighted body 12 to more easily move in a vertical direction (see FIG. 8) through the water. In another embodiment of the invention, the weighted body 12 may have a generally cylindrical portion 18 disposed between the conical upper 15 and lower 16 portions.

The weighted body 12 may be manufactured in variety of shapes and should not be considered to be limited to those illustrated. For instance, the weighted body 12 may be manufactured in a shape generally resembling a prey of fish. Additionally, the weighted body 12 may be manufactured from a variety of materials such as, for example, lead or steel. Non-metallic materials may also be used and weights may be added to permit the weighted body 12 to sink in the water.

In one embodiment of the invention, an outer surface of the weighted body 12 may be smooth to decrease the amount of drag or resistance across its surface and thereby increase a rate of movement through the water. In another embodiment of the invention, the outer surface of the weighted body 12 may be generally textured to increase the amount of drag over the weighted body 12 and thereby cause the weighted body 12 to undulate as it moves in the water. The purpose of the undulating movement of the weighted body 12 is to attract fish. The outer surface may have a plurality of ridges that extend along or about the weighted body 12. Other types of textures may also be imprinted or formed on the weighted body 12 either at the time of manufacture or afterward by any engraving, etching or any other mechanical or chemical methods known to one skilled in the art.

Referring to FIGS. 2-3 and 8, a coupling member 20 is preferably coupled or couplable to the first end 13 of the weighted body 12 for detachably coupling the weighted body 12 to a fishing line denoted as letter A in FIG. 8. In one embodiment of the invention, the coupling member 20 includes an anchor portion 22 coupled to or swively disposed on the first end 13 of the weighted body 12. A leader portion 24 may also be swively disposed on the anchor portion 22 for receiving a leader line B and a fishing hook C. A securing portion 26 may also be swively disposed on the anchor portion 22 for securing the weighted body 12 to the fishing line A. The anchor portion 22, leader portion 24 and securing portion 26 may be generally annular. However, the anchor 22, leader 24 and securing 26 portions may have any shape and any configuration that would facilitate the coupling of the weighted body to the fishing line A and leader line B.

In one embodiment of the present invention, the leader portion 24 and securing portion 26 may be generally oriented at an angle with respect to the weighted body 12 and to each other. Referring back to FIG. 8, in this particular orientation a longitudinal axis of the fishing line may be orientated generally perpendicular to the floor of the body of water and a longitudinal axis of the weighted body 12 may be oriented generally at an angle to the floor of the body of water and the fishing line A. The leader line B connected to the leader portion 24 may be oriented generally parallel to the floor of the body of water. Other embodiments having the anchor 22, leader 24 and securing 26 portions orientated at varying angles to each other are envisioned within the scope and spirit of the invention.

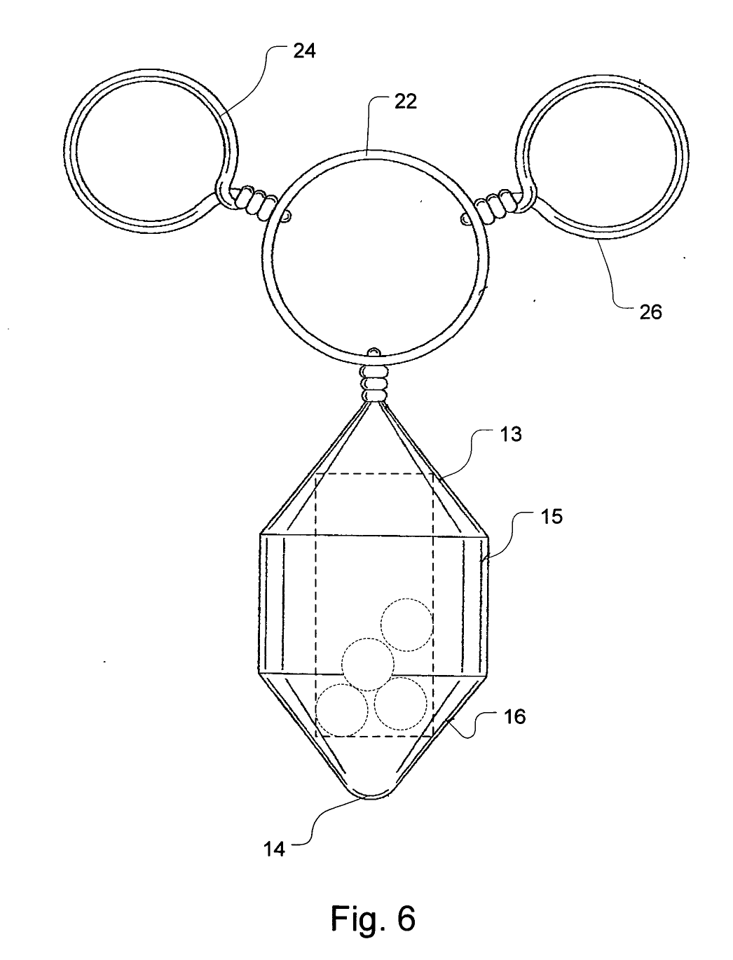

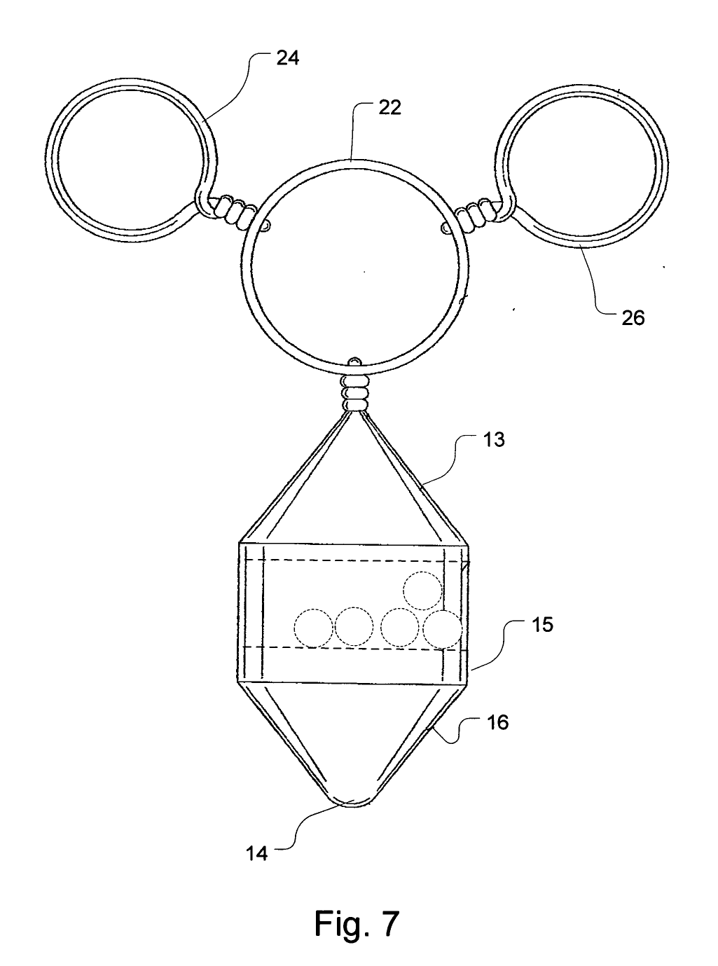

Referring to FIGS. 6 and 7, a noise generating mechanism 30 may be disposed in an interior or cavity of the weighted body 12 to generate noise under water and attract fish to the fish luring device 10. In one embodiment, as particularly illustrated in FIG. 6, the noise generating mechanism 30 may be axially disposed in the weighted body 12. In another embodiment of the invention, as particularly illustrated in FIG. 7, the noise generating mechanism 30 may be disposed generally transverse to a longitudinal axis of the weighted body 12. The noise generating mechanism 30 may include a cylinder 32 or other shape disposed or formed in the weighted body 12 and may include at least one ball or other noise generating member 34 moveably disposed in the cylinder 32. As particularly illustrated in FIG. 6, a plurality of noise generating members 34 may be disposed in the cylinder 32.

In another embodiment of the invention, a plurality of noise generating mechanisms 30 may be disposed in the weighted body 12. The noise generating mechanisms 30 may be oriented in a plurality of positions with respect to the weighted body 12 in order to increase the generation of noise from the weighted body 12. Although the figures illustrate the noise generating mechanism or mechanisms 30 disposed in the weighted body 12, other embodiments having the noise generating mechanism disposed on or through the weighted body 12 are also envisioned.

In use, a user or angler secures a fishing line to the securing portion 36 of the coupling member 20. A leader line having at least one hook is then tied or attached to the leader portion 36 of the coupling member 20. Bait can be disposed on the fishing hook before casting or putting the fish luring device 10 into the water. The weighted body 12 is then permitted to fall through the water and to come into contact with the floor of the body of water. Debris from the floor of the body of water is stirred around the weighted body 12, thereby attracting fish toward the debris. The weighted body 12 is then lifted from the floor by the angler and allowed to fall back through the water until it comes into contact with the floor again. These steps are repeated until a fish is caught by the angler.

In an embodiment of the invention having a noise generating mechanism 30, noise may be generated when the weighted body 12 comes into contact with the floor of the body of water. In particular, when the weighted body 12 comes into contact with the floor of the body of water the noise generating members 34, which may be balls collide with an inner surface of the cylinder 32 and each other. The vibrations and noise generated by the ball or balls colliding emanates through the water to attract the fish. In another embodiment, the noise generating mechanism 30 emanates noise from the weighted body 12 at periodic intervals or continuously while the angler is fishing.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A fish luring device for coupling to an end of a fishing line of a fishing pole, the device comprising:
a body to engage a floor of a body of water,
a coupling member disposed to a portion of the body having a leader portion for coupling to a leader fishing line and a securing portion for coupling to the fishing line from the fishing pole; and
wherein the body engages the floor of the body of water stirring debris thereon to attract fish the leader fishing line extending from the coupling member.

2. The device of claim 1, further including a disturbance generating means being disposed within the body to generate a disturbance that attracts fish thereto.

3. The device of claim 2, wherein the noise generating means emits a noise.

4. The device of claim 2, wherein the noise generating means emits a vibration.

5. The device of claim 1, further including a plurality of balls disposed within the body to collide with each other and an interior of the body to generate a noise and attract fish thereto.

6. The device of claim 1, further including at least one ball disposed within an interior of the body to collide with at least an inner surface thereof to generate a noise that attracts fish.

7. The device of claim 1, wherein the body includes a generally conical upper portion and a generally conical lower portion to permit the body to easily raise and lower through water such that the body can engage the floor of the body of water to attract fish.

8. The device of claim 1, wherein the body includes at least a portion of a generally rough surface to engage and stir up the debris on the floor of the body of water.

9. The device of claim 1, wherein the leader portion and the securing portion are oriented at an angle to each other such that the leader line extends generally horizontally from the coupling member.

10. A fish luring device for coupling to an end of a fishing line of a fishing pole, the device comprising:
a body to engage a floor of a body of water,
a noise generating means being disposed within the body to generate a noise and attract fish thereto;
a coupling member disposed to a portion of the body having a leader portion for coupling to a leader fishing line and a securing portion for coupling to the fishing line; and
wherein the body engages the floor of the body of water stirring debris thereon to attract fish, which can then engage the leader fishing line extending from the coupling member.

11. The device of claim 10, further including a plurality of balls disposed within the body to collide with each other and an interior of the body to generate a noise and attract fish thereto.

12. The device of claim 10, wherein the body includes a generally conical upper portion and a generally conical lower portion to permit the body to more easily drop through water.

13. The device of claim 12, wherein the body includes a generally cylindrical portion disposed between the generally conical upper and lower portions.

14. The device of claim 10, wherein the body includes a generally rough surface to engage and stir up the debris on the floor of the body of water.

15. The device of claim 10, wherein the leader portion and the securing portion are oriented at an angle to each other such that the leader line extends generally horizontally from the coupling member.

16. The device of claim 10, wherein the coupling member further includes an anchor portion coupled to and disposed between the body, leader portion and securing portion.

17. The device of claim 16, wherein the leader portion and the securing portion are rotatably coupled to the anchor portion.

18. A method of attracting fish to a fish luring device comprising the steps of:
providing a fish luring device having a body that is coupled to an end of a fish line and a lead line having a fish hooking means;
dropping the body attached to the fish line through a body of water until it engages a floor of the body of water; and
repeatedly lifting and dropping the body to engage the floor of the body of water to stir up debris therefrom to attract fish toward the debris, wherein the fish engages the fish hooking means.

19. The method of claim 18, further comprising the step of providing a disturbance generating means disposed to the body to generate a disturbance when the body engages the floor of the body of water, such that fish are attracted to the body by the disturbance.

20. The method of claim 18, further comprises the step of providing a coupling member disposed between the body, lead line and fish line.
